(19) United States
(12) Patent Application Publication
(10) Pub. No.: US 2012/0044031 A1
(43) Pub. Date: Feb. 23, 2012

(54) Magnetic Connector

(75) Inventor: Tomoyasu NINOMIYA, Tokyo (JP)

(73) Assignee: SEBERU PICO CO., LTD., Tokyo (JP)

(21) Appl. No.: 13/213,615

(22) Filed: Aug. 19, 2011

(30) Foreign Application Priority Data
Aug. 20, 2010 (JP) 2010-185653
Nov. 12, 2010 (JP) 2010-253830

(51) Int. Cl. H01F 1/00

(52) U.S. Cl. 335/219

(57) ABSTRACT

A magnetic connecting device, which is easily separated without both hands but one that is not easily separated in a direction in which a pulling force is applied, is disclosed. Each of a pair of coupling pieces is respectively provided with each of a pair of coupling piece main bodies including joint surfaces capable of joining each other. At least one magnet piece is embedded in each of the joint surfaces such that the coupling piece main bodies attract to join each other. An attaching piece for attaching a string body is provided on each of the coupling pieces, and is provided with a slide guide structure formed on a side of the joint surface of each of the coupling piece main bodies for slidingly guiding the other in a predetermined direction with respect thereto.

### TECHNICAL FIELD

The field relates to a magnetic coupling device attached to both ends of a string body such as an accessory such as a necklace and a bracelet, a waist belt, and other removable belts for coupling both the ends of the string body or releasing the connection.

### BACKGROUND

The patent document 1 discloses a coupling device in which a tenon 113 (or dovetail) and a mortise 115 (or dovetail groove) are formed on one and the other of facing surfaces of magnets 111 and 121 in a direction perpendicular to a direction in which pulling force is applied illustrated in FIG. 24 (hereinafter, appropriately referred to as a “conventional coupling device”). There is an objective function that both the magnets attracting each other are not easily separated when pulling external force is applied by allowing the tenon to fit in the mortise.
The Patent Document 1 referenced is Japanese Utility Model Application Laid-Open No. 60-79313, which makes reference to FIGS. 1 and 2.

Although the above-described conventional coupling device has an effect to prevent separation when the pulling force is applied in a longitudinal direction of the string body, this is significantly inconvenient when it is tried to release the connection. As understood from FIG. 24, in order to separate one magnet from the other magnet attracting each other, it is required to hold the one magnet with fingers of one hand and pick the other magnet with the fingers of the other hand to pull the one in a direction to separate from the other (upward in FIG. 36 of the Publication) against magnetic force. That is to say, it is required to use both hands for separating the magnets. Further, since the coupling device used in the necklace is much smaller than a finger pad, it is quite difficult to pick the same with a thumb and an index finger, for example, and it is difficult to pick both of the magnets with fingers of both hands to separate them from each other beyond expectation. The difficulty is a disadvantage of the conventional coupling device. There remains to be a need for improved coupling devices.

### SUMMARY OF THE INVENTION

### Characteristics of Invention According to Claim 1

A magnetic coupling device according to one example of the invention according to claim 1 (hereinafter, appropriately referred to as the “coupling device according to claim 1”) is provided with a pair of coupling pieces, wherein each of the coupling pieces is provided with each of a pair of coupling piece main bodies including joint surfaces capable of joining each other, at least one (one or a plurality of) magnet piece(s) embedded in each of the joint surfaces such that the coupling piece main bodies attract to join each other, and an attaching piece for attaching a string body provided on each of the coupling pieces, and is provided with a slide guide structure formed on a side of the joint surface of each of the coupling piece main bodies for slidingly guiding the other in a predetermined direction with respect thereto and preventing relative movement of each of the coupling piece main bodies in a string body pulling direction when being pressed to be released. As far as the one magnet piece and the other magnet piece may attract each other, a material and a shape thereof are not limited. A polarity is not limited either, and monopole such that the polarity appearing on one of attracting surfaces is the north pole and the other is the south pole is possible, for example, and multipole such that a plurality of north poles and a plurality of south poles appear is also possible. Further, if a plurality of (for example, two) monopolar magnets in which the north pole and the south pole appear in a thickness direction are prepared and they are arranged such that the polarity on the attracting surface of one magnet is opposed to the polarity on the attracting surface of the adjacent magnets, the same effect as the multipolar magnet may be obtained.

According to the coupling device according to claim 1, a pair of coupling devices are composed of one coupling piece and the other coupling piece, and each of the coupling pieces is provided with the coupling piece main body and the attaching piece. The joint surface of the one coupling piece main body and the joint surface of the other coupling piece main body may join each other and joint of both of them is realized by attraction of the one magnet piece and the other magnet piece embedded in both of them. The pulling force is applied to the one coupling piece main body and the other coupling piece main body through the attaching piece attached to each of them and the string body attached to the attaching pieces. Although the pulling force acts in a direction to move the one coupling piece main body with respect to the other coupling piece main body, the movement is prevented by the slide guide structure. The slide guide structure further guides to slide the one coupling piece main body with respect to the other coupling piece main body in a predetermined direction different from the pulling direction. If the other coupling piece main body is moved in a direction to be separated from the one coupling piece, both the hands are required to hold the one and separate the other, but it is configured to move the same in a contacting state, that is to say, to slide, so that only one hand is required.

A problem to be solved by the present invention is for solving the previously described disadvantage of the conventional coupling device, and for providing the magnetic coupling device in which one of the magnets attracting each other may be separated from the other only by picking the same with the thumb and the index finger, for example, of one hand without using both the hands, while the magnets are not easily separated in the direction in which the pulling force is applied.

For solving the above-described problem, in order to enable slide of one of the coupling pieces attracting each other with respect to the other by the fingers of only one hand for separating the one from the other, it is devised in the present invention a structure to allow such slide but prevent easy separation in the pulling direction. Detailed contents are, described in a following paragraph. Meanwhile, definition and the like of a term for describing the invention according to any one of claims is also applied to the invention according to another claim within an available scope in the nature irrespective of the order of description.

### Characteristics of Invention According to Claim 2

The magnetic coupling device according to the invention according to claim 2 (hereinafter, appropriately referred to as the “coupling device according to claim 2”) is the coupling device according to claim 1, wherein the slide guide structure includes a projected wall projected from the joint surface of each of the coupling piece main bodies and a retreated wall retreated from the joint surface, and is configured that one of the projected walls and the other of the retreated walls, and the other of the projected walls and one of the retreated walls are brought into slide contact with each other in the slide direction, and the relative movement in the string body pulling direction is prevented.

According to the coupling device according to claim 2, the projected wall of the one coupling piece main body and the retreated wall of the other coupling piece main body, and the projected wall of the other coupling piece main body and the retreated wall of the one coupling piece main body are brought into slide contact with each other, and according to this, the other coupling piece main body slides in the predetermined direction with respect to the one coupling piece main body. On the other hand, the slide contact prevents the relative movement of each of the coupling piece main bodies in the string body pulling direction. From above, a function effect of the slide guide structure of claim 1 is generated.

### Characteristics of Invention According to Claim 3

The magnetic coupling device according to the invention according to claim 3 (hereinafter, appropriately referred to as the “coupling device according to claim 3”) is the coupling device according to claim 1 or 2, wherein the predetermined direction is inclined with respect to the string body pulling direction. Herein, the term “incline” is intended to mean that, when the pulling direction of the coupling piece main body in a planar view is in a direction of 12 o'clock (6 o'clock), an angle between the same and the predetermined direction is an acute angle, further, when the pulling direction of the coupling piece main body in a side view is in a direction of 3 o'clock (9 o'clock), an angle between the same and the predetermined direction is an acute angle, and further, when the pulling direction is in the direction other than the above-described two directions, an angle between the same and the predetermined direction is an acute angle.

According to the coupling device according to claim 3, it is possible to press to release in a direction inclined with respect to the pulling direction, so that although depending on a size and a shape of the coupling device, press to release becomes easy in general. That is to say, although it is not prevented to be at a right angle with respect to the pulling direction, operation of the press to release at the acute angle performed on a palm is easier in general than that at the right angle.

### Characteristics of Invention According to Claim 4

The magnetic coupling device according to the invention according to claim 4 (hereinafter, appropriately referred to as the “coupling device according to claim 4”) is the coupling device according to any one of claims 1 to 3, wherein the magnet piece is provided with at least a pair (or two or more pairs) of the north pole and the south pole arranged in the slide direction on an attracting surface thereof, and positions of the north pole and the south pole in one magnet piece and the other magnet piece are reversed. That is to say, if the north pole and the south pole are arranged in the slide direction on the attracting surface of the one magnet piece, the south pole and the north pole are arranged in the same direction on the attracting surface of the other magnet piece.

According to the coupling device according to claim 4, in addition to the function effect of the coupling device according to claims 1 to 3, both of the magnet pieces attract each other such that the north pole of the one and the south pole of the other are opposed to each other, and the south pole of the other and the north pole of the one are opposed to each other at the time of connection. When there are a plurality of pairs of magnet pieces, each pair of magnet pieces attract each other in the same mode. On the other hand, when the coupling device is pressed in a releasing direction, the relative movement is generated between the magnet pieces attracting each other and the above-described opposing relationship disappears, and the same poles are opposed to each other between the magnet pieces such as the north pole and the north pole or the south pole and the south pole. When the same poles are opposed to each other, repelling force is generated between both the magnet pieces, and according to this, the one coupling piece main body (coupling piece) and the other coupling piece main body (coupling piece) are separated from each other and the connection is released. Since the repelling force of the magnets acts, the connection of the magnet pieces may be easily released.

### Characteristics of Invention According to Claim 5

The magnetic coupling device according to the invention according to claim 5 (hereinafter, appropriately referred to as the “coupling device according to claim 5”) is the coupling device according to any one of claims 1 to 4, wherein at least one or a plurality of laminated yoke pieces are arranged on a side opposite to the attracting surface of the magnet piece.

According to the coupling device according to claim 5, in addition to the function effect of the coupling device according to any one of claims 1 to 4, a magnetic circuit is configured by arranging the yoke piece, and as a result, leakage of a magnetic flux from the magnet piece decreases and attraction (repulsion) of the magnet pieces (coupling pieces) becomes efficient by a decreased amount.

### Characteristics of Invention According to Claim 6

The magnetic coupling device according to the invention according to claim 6 (hereinafter, appropriately referred to as the “coupling device according to claim 6”) is the coupling device according to any one of claims 1 to 5, wherein the slide guide structure is further configured to slidingly guide the coupling piece main bodies in directions away from each other when being pressed to release magnetic joint of the coupling piece main bodies or assist the release.

According to the coupling device according to claim 6, in addition to the function effect of the coupling device according to any one of claims 1 to 5, release of the connection of the one coupling piece main body from the other coupling piece main body may be easily performed by the release or assistance of the release of the slide guide structure. That is to say, the farther it is, the more the magnetic force is attenuated, so that while it is in a sliding state, the connection may be released with smaller force as a distance between the one coupling piece and the other coupling piece (space deposition formed therebetween) increases.

### Characteristics of Invention According to Claim 7

The magnetic coupling device according to the invention according to claim 7 (hereinafter, appropriately referred to as the “coupling device according to claim 7”) is the coupling device according to any one of claims 1 to 6, wherein each of the coupling piece main bodies is such that an open end of one coupling piece main body is projected from a close end of the other coupling piece main body and the open'end of the other coupling piece main body is projected from the close end of the one coupling piece main body in a slide direction in a state of attracting to join each other, and is configured to release the magnetic joint of the coupling piece main bodies or to assist the release when the open end of the one coupling piece main body and the open end of the other coupling piece main body are pressed in directions to be brought closer to each other.

According to the coupling piece according to claim 7, in addition to the function effect of the coupling device according to any one of claims 1 to 6, since the open end of each is projected from the close end, the finger is put on the portion, but the finger is not put on the close end. That is to say, the force to press them in the directions to bring them closer to each other is applied only to the open end and is not applied to the close end. The pressing forces are applied in the directions to bring them closer to each other, that is to say, in opposite directions, so that they may be applied by one hand and it is not necessary to use the other hand. If the force is applied to the other close end simultaneously with the one open end, it is not possible to move both of them in the opposite directions, so that the above-described release of the connection is not realized.

### Characteristics of Invention According to claim 8

The coupling device according to claim 8 is the coupling device according to claim 6, wherein each of the open ends is composed of an extended open end formed of a projected piece projected from each of the coupling piece main bodies.

According to the coupling device according to claim 8, in addition to the function effect of the coupling device according to claim 6, the open end is projected than the other close end by a projected amount of the extended open end, and the pressing force applied through the extended open end is in the directions in which the coupling piece main bodies are brought closer to each other, that is to say, in the opposite directions, so that the connection may be released by one hand.

### Characteristics of Invention According to Claim 9

The coupling device according to claim 9 is the coupling device according to claim 8, wherein the one projected piece and the other projected piece are arranged such that a direction of a virtual straight line passing through both of them intersects the slide direction.

According to the coupling device according to claim 9, in addition to the function effect of the coupling device according to claim 8, since the direction of the virtual straight line intersects the slide direction, when it is tried to bring the one projected piece and the other projected piece closer to each other, the fingers put on them are moved in the direction different from the slide direction. When the fingers are moved in the same direction as the slide direction, the coupling pieces slide with respect to each other, and although depending on the size and the shape of the coupling device, there is a case in which the coupling piece, which slides, hits, against the finger to obstruct the release operation. Therefore, by moving the fingers in the direction different from the slide direction, it is configured that the coupling piece does not easily hit against the finger, thereby making the release operation easy.

### Characteristics of Invention According to Claim 10

The magnetic coupling device according to the invention according to claim 10 (hereinafter, appropriately referred to as the “coupling device according to claim 10”) is the coupling device according to any one of claims 1 to 8, wherein the string body is a necklace.

According to the coupling device according to claim 10, the function effect of the coupling device according to any one of claims 1 to 9 preferably acts on the necklace. Although depending on a length, the connection of the necklace and the release thereof are often performed out of eyeshot of the user (for example, just below a chin or behind a neck), so that advantage of the release of the connection with one hand is large. It goes without saying that application of the present invention is not limited only to the necklace but the string body includes other than the necklace such as the bracelet and the waist belt.

### Advantageous Effects of Invention

In order to enable the slide of one of the coupling pieces attracting each other with respect to the other with the fingers of only one hand so as to separate the one from the other, such slide is allowed and easy separation in the pulling direction may be prevented.

### BRIEF DESCRIPTION OF THE DRAWINGS

FIG. 1 is a perspective view of a magnetic coupling device according to this embodiment applied to a belt.

FIG. 2 is an exploded perspective view of the coupling device illustrated in FIG. 1.

FIG. 3 is a planar view of the coupling device illustrated in FIG. 1.

FIG. 4 is a planar view of one coupling piece, which composes the coupling device illustrated in FIG. 1.

FIG. 5 is a cross-sectional view taken along line A-A of the coupling device illustrated in FIG. 3.

FIG. 6 is a cross-sectional view taken along line B-B of the coupling device illustrated in FIG. 3.

FIG. 7 is a view of the coupling piece illustrated in FIG. 4 seen in a direction indicated by an arrow Z.

FIG. 8 is a schematic front view illustrating a polarity of a magnet piece.

FIG. 9 is a planar view of the coupling device according to a first modified example of this embodiment.

FIG. 10 is a view of the coupling device illustrated in FIG. 9 seen in a direction indicated by an arrow Y.

FIG. 11(a) is a planar view of one coupling piece, which composes the coupling device illustrated in FIG. 9, and FIG. 11(b) is a side view of FIG. 11(a).

FIG. 12(a) is a planar view of a reverse side of the other coupling piece, which composes the coupling device illustrated in FIG. 9, and FIG. 12(b) is a side view of FIG. 12(a).

FIG. 13 is a cross-sectional view taken along line C-C of the coupling device illustrated in FIG. 9.

FIG. 14 is a perspective view of the coupling device according to a second modified example of this embodiment applied to the necklace.

FIG. 15 is a front view of the coupling device illustrated in FIG. 14.

FIG. 16(a) is a planar view of the coupling device illustrated in FIG. 14, and FIG. 16(b) is a view of FIG. 16(a) as seen in a direction indicated by an arrow X.

FIG. 17(a) is a planar view of one coupling piece, which composes the coupling device illustrated in FIG. 14, and FIG. 17(b) is a view of FIG. 17(a) seen in a direction indicated by an arrow W.

FIG. 18 is a cross-sectional view taken along line D-D of the coupling device illustrated in FIG. 16.

FIGS. 19(a) to 19(e) are front views of examples in which the number and a shape of slide projected pieces and slide grooves of the coupling device illustrated in FIG. 15 are changed.

FIG. 20 is a front view of the coupling device according to a third modified example of this embodiment.

FIGS. 21(a) and 21(b) are exploded perspective views of the coupling device illustrated in FIG. 20.

FIG. 22 is a planar view of one coupling piece, which composes the coupling device illustrated in FIG. 20.

FIG. 23 is a cross-sectional view taken along line E-E of the coupling piece illustrated in FIG. 22.

FIG. 24 is a side view of a conventional coupling device (Japanese Unexamined Utility Model Application Laid-Open Publication No. S60-79313 (FIG. 1(a)).

### DETAILED DESCRIPTION

The examples and drawings provided in the detailed description are merely examples, which should not be used to limit the scope of the claims in any claim construction or interpretation.

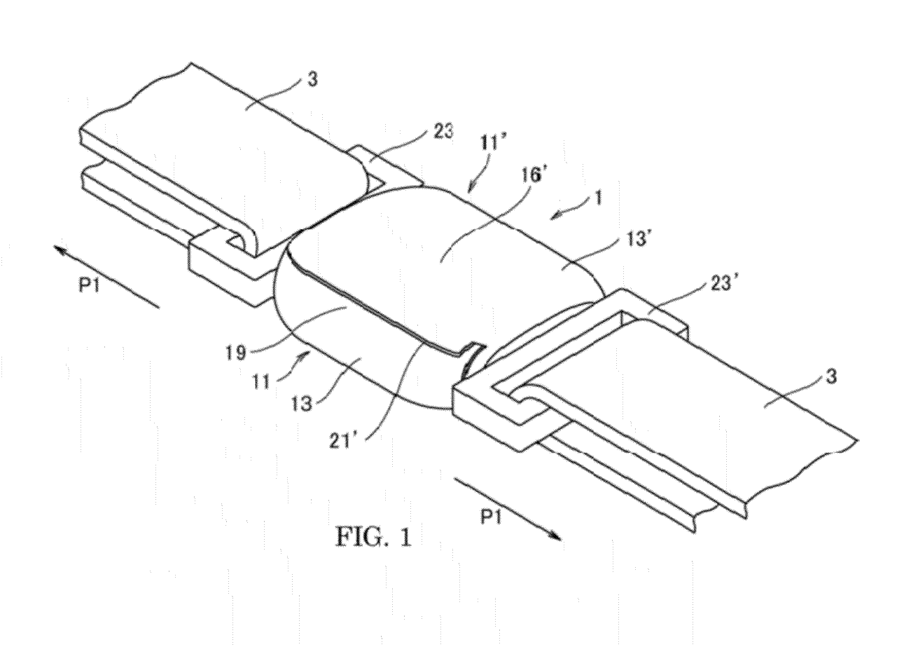

An embodiment for carrying out the present invention (hereinafter, referred to as “this embodiment”) is described with reference to the drawings. A magnetic coupling device (hereinafter, simply referred to as a “coupling device”) according to this embodiment is applied to a necklace as illustrated in FIG. 1.

### (Schematic Structure of Coupling Device)

As illustrated in FIGS. 1 to 3, a coupling device 1 is configured to connect and release connection of both ends of a string body (belt in this embodiment) 3. Principal components of the coupling device 1 are a pair of coupling pieces 11 and 11′. The coupling pieces 11 and 11′ are in a line-symmetrical relationship with respect to an axis of symmetry when they are arranged such that the attaching pieces 23 and 23′ included therein are arranged next to each other with the axis of symmetry interposed therebetween. That is to say, the difference between the coupling pieces 11 and 11′ arranged next to each other is only that the right and left sides of shapes thereof are reversed except that polarities of magnet pieces 31 and ′31 are different from each other (magnets attract each other). Therefore, although the coupling piece 11 is essentially described in a following description unless otherwise specified, the description also applies to the coupling piece 11′. The same also applies to a member and a part included in the coupling pieces 11 and 11′. The polarities of the magnet pieces 31 and 31′ will be described again later.

### (Structure of Coupling Piece)

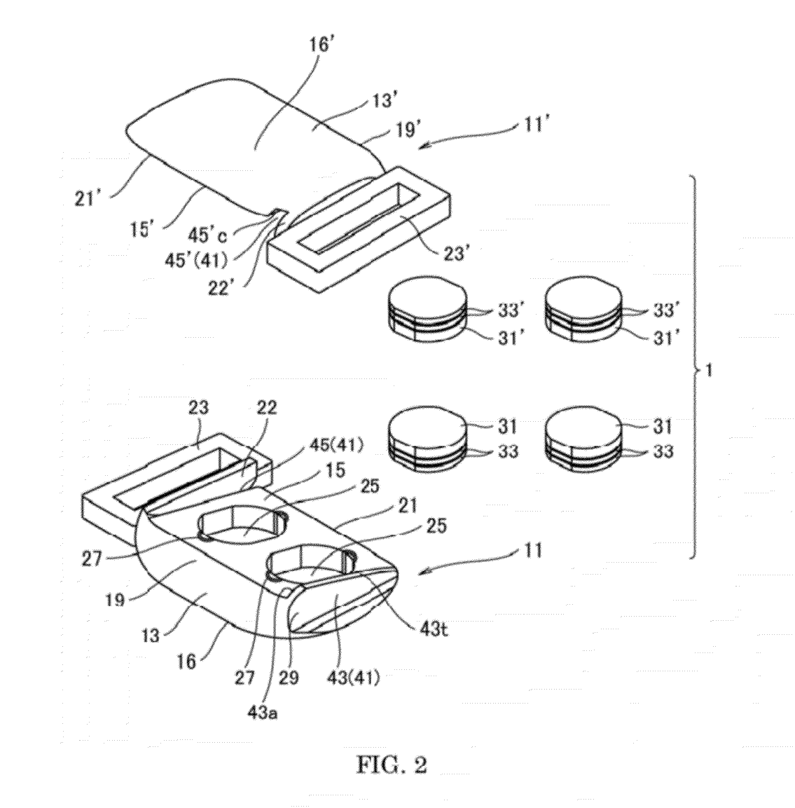

As illustrated in FIGS. 2 to 4, the coupling piece 11 is provided with a coupling piece main body 13, which is substantially rectangular in a planar view, a joint surface 15 formed on one side of the coupling piece main body 13, a supporting piece 22 formed on one short side of the coupling piece main body 13, the attaching piece 23 provided on the supporting piece 22, and a slide guide structure 41. A surface 16 of the coupling piece main body 13 on a side opposite to the joint surface 15 rises into a smooth mountain shape. The joint surface 15 is inclined with respect to the surface 16, and the joint surface 15, the surface 16, and an open end 19 interposed therebetween form a substantially triangular shape in a side view. Therefore, when the coupling pieces 11 and 11′ are connected, the triangular shapes are stacked on each other to form a substantially rectangular shape in a planar view. Meanwhile, an end at which the joint surface 15 and the surface 16 intersect with each other is referred to as a close end 21. The close end 21 and the open end 19 are opposed to each other with the joint surface 15 interposed therebetween.

The joint surface 15 is formed so as to be substantially planar and is capable of sliding with respect to the joint surface 15′, which joins the same. On the joint surface 15, a plurality of (herein two, and may also be at least one) embedded holes 25 arranged in a longitudinal direction are formed. Each of the embedded holes 25 is formed into a substantially circular shape of which two opposed portions are linear, and fixing claws 27 and 27 are formed on two portions of a peripheral edge thereof. The embedded hole 25 is a hole in which the magnet piece 31 and a yoke 33 are embedded to be adhered with an adhesive, and this is formed into the above-described shape so as to prevent the magnet piece 31 from rotating in a direction parallel to the joint surface 15 with respect to the coupling piece 11. The fixing claws 27 and 27 are formed by cutting column shapes from a peripheral wall of the embedded hole 25 with only lower ends left, and they are bent inward to serve to hold the magnet piece 31 in the coupling piece 11 within the embedded hole 25 and fix the same, thereby preventing the rotation thereof. That is to say, it is configured that the magnet piece 31 is fixed by a shape of the embedded hole 25 and by the fixing claws 27 and the rotation thereof is prevented. Meanwhile, the embedded magnet pieces 31 and 31′ have substantially circular shapes and it is required that they are provided with the polarity and magnetic force such that the joint surface 15 (coupling piece 11) and the joint surface 15 (coupling piece 11′) attract to join each other by attraction of the magnet pieces 31 and 31′. Further, it is also required that embeddedness does not prevent slide of the joint surface 15 with respect to the joint surface 15′. Meanwhile, the above-described yoke 33 is used to inhibit leakage of a magnetic flux from the magnet piece 31.

### (Polarity of Magnet Piece)

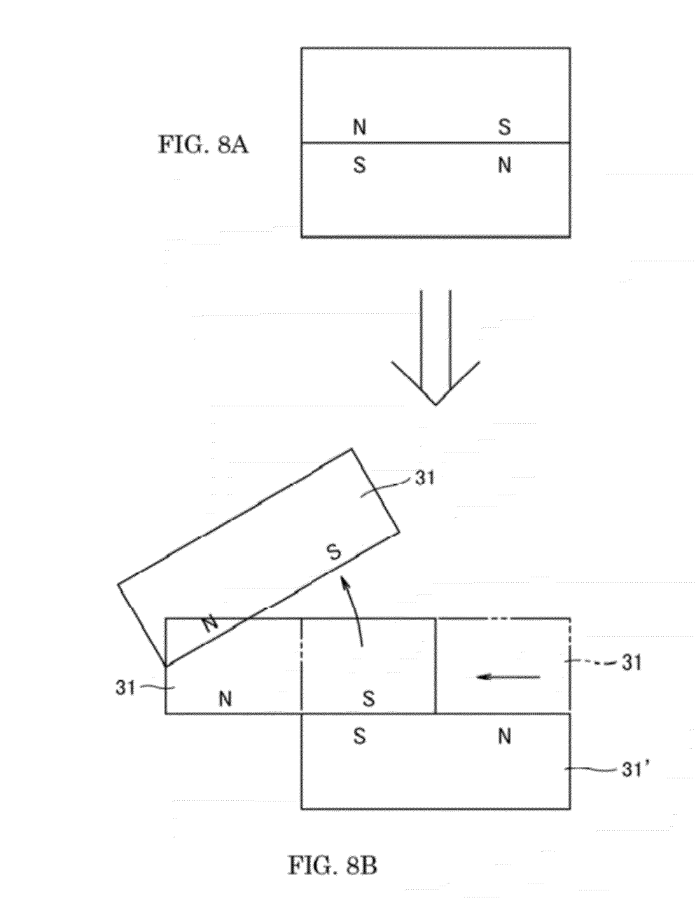

The polarity of the magnet piece is described with reference to FIGS. 8 A and B. As the polarities of one and the other of the magnet pieces 31 and 31′, the polarities appearing on attracting surfaces opposed to each other are made different from each other such that both the magnet pieces attract each other. The simplest method is to make the appearing polarity either of the north pole and the south pole and set the polarity appearing on the opposed attracting surface to a reverse polarity. On the other hand, a preferred mode adopted in this embodiment makes release of the connection easier by utilizing homopolar repulsion. That is to say, the magnet piece 31 is provided with a pair (or two or more pairs such as a double-sided multipolar magnet) of north pole and south pole arranged in a slide direction (right-left direction in FIG. 8) on the attracting surface thereof, and positions of the north pole and the south pole of the magnet piece 31′ are reversed from those of the magnet piece 31. According to this, in an attracting-coupled state as illustrated in FIG. 8(a), if a pressure is applied to release as indicated by an arrow, the magnet piece 31 slides (relatively moves) in a slide direction. Then, by the slide, the polarities, which are different from each other in the attracting-connected state, become the same polarity and repelling force is generated as illustrated in FIG. 8(b). The repelling force moves the coupling pieces 11 and 11′ in directions away from each other, and as a result, the connection therebetween is released. Utilization of the repelling force makes the release of the connection extremely easy. However, this does not prevent a configuration to release the connection only by an effect of the slide guide structure to be described later without utilizing the repelling force between both of the polarities. Although the north pole and the south pole are arranged in line in the slide direction according to the mode of this embodiment described above, the north pole and the south pole are arranged in line in a direction across the slide direction when the repulsion between both of the polarities is not utilized.

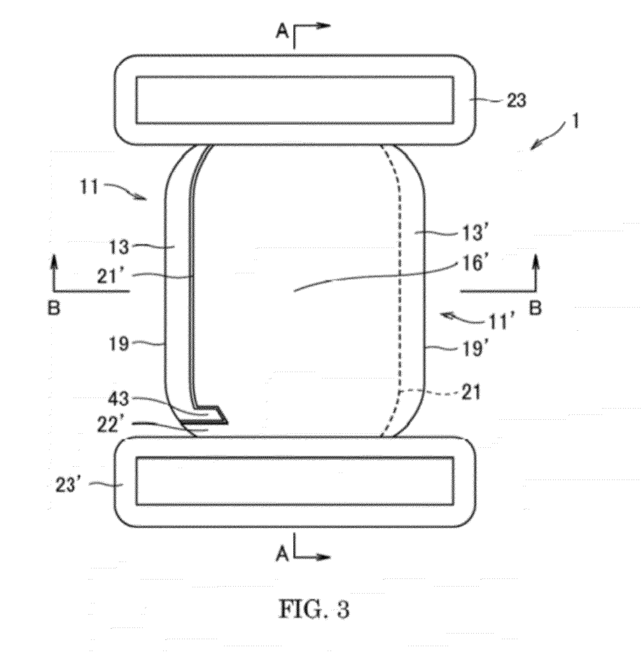

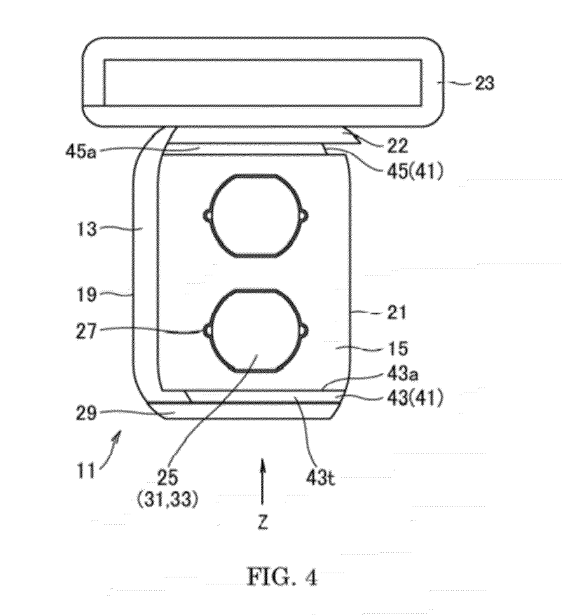

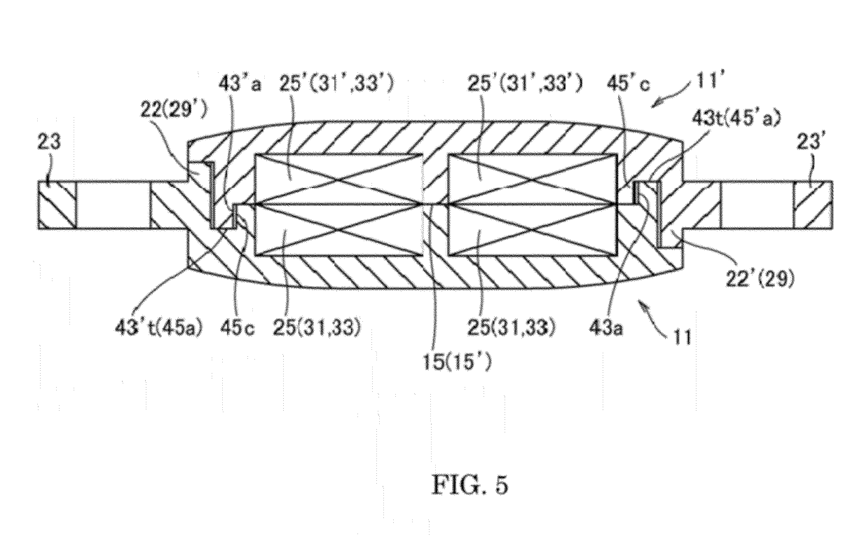

The attaching piece 23 is formed into a flat O-shape obtained by flattening an alphabet “O” integrally formed with the supporting piece 22 on one short side of the coupling piece 11, which is rectangular (another member may be fixed). The attaching piece 23 is a part to which the string body 3 (refer to FIG. 1) such as the belt is fixed. The flat O-shape is adopted because this is convenient for passing a flat belt therethrough and bending the same to fix. As long as the string body satisfies its function, this is not necessarily limited to the above-described shape and also this is not required to be a ring shape. Also, when a metallic string body is fixed to the attaching piece 23 (supporting piece 22) by fixing means (not illustrated) such as welding, for example, the fixing means corresponds to the attaching piece 23. When coupling the coupling pieces 11 and 11′, the attaching pieces 23 and 23′ are opposed to each other with the coupling piece main bodies 13 and 13′ interposed therebetween in a planar view (refer to FIG. 3). The slide guide structure 41 is described in a next paragraph. Meanwhile, a reference sign 29 in FIGS. 2 and 4 represents a receiving concave portion for receiving the supporting piece 22′ (refer to FIG. 3). A receiving concave portion 29′ for receiving the supporting piece 22 is illustrated in FIG. 5.

### (Structure of Slide Guide Structure)

As illustrated in FIGS. 2 to 4, the slide guide structure 41 serve to slidingly guide one formed on a side of the joint surface 15 of each of the coupling pieces 11 with respect to the other in a predetermined direction and to prevent relative movement of each of the coupling pieces 11 in a string body pulling direction when being pressed. A specific structure for realizing the function is as follows. That is to say, a slide projected piece 43 is provided on an end of the joint surface 15 on a side opposite to a side on which the attaching piece 23 is provided so as to be projected from the joint surface 15 (refer to FIG. 4). The slide projected piece 43 includes a projected wall 43a projected from the joint surface 15 and is formed into an elongated shape substantially parallel to the short side of the coupling piece 11 and extending in a substantially entire short side of the joint surface 15 (extending direction is referred to as “slide direction”). Meanwhile, an upper end face 43t of the slide projected piece 43 is inclined with respect to the joint surface 15.

A slide groove 45 is a part of the slide guide structure 41 and forms a pair with the slide projected piece 43. The slide groove 45 is an elongated groove including a retreated wall 45c retreated from the joint surface 15 and extending in a direction along the short side on a side of the attaching piece 23 of the joint surface 15, that is to say, in the slide direction. The slide grooves 45 and 45′ are formed into shapes capable of receiving the slide projected pieces 43′ and 43, respectively, so as to be slidable in the slide direction. One projected wall 43a and the other retreated wall 45′c, and the other projected wall 43′a and one retreated wall 45c thus configured are brought into slide contact with each other in the slide direction and prevent the relative movement in the string body pulling direction.

On the other hand, a groove bottom 45a (refer to FIG. 4) of the slide groove 45 is inclined with respect to the joint surface 15 at an angle substantially the same as that of the slide projected piece 43′ of the coupling piece 11′ in an opposite direction. The upper end face 43t (upper end face 43′t) and the groove bottom 45a (groove bottom 45′a) at the time of connection are in an opposing relationship without preventing the connection between the coupling pieces 11 and 11′. On the other hand, the coupling pieces 11 and 11′, which tend to slide by being pressed, guide the coupling pieces 11 and 11′ slidingly guided by a slide action of the upper end face 43t (upper end face 43′t) and the groove bottom 45a (groove bottom 45′a) at the time of connection also in directions away from each other. That is to say, the slide guide structure 41 is configured to simultaneously guide one against the other, that is to say, the coupling piece 11′ against the coupling piece 11 in a direction parallel to the joint surface 15 and in a direction away from the joint surface 15 (direction obtained by synthesizing both the directions).

In the slide in the direction parallel to the joint surface 15, by lateral slide of the attracting surfaces of the magnet pieces 31 and 31′ attracting each other, they are not subjected to a magnetic force effect, and according to this, the joint is released or the release is assisted. On the other hand, by sliding to separate the magnet pieces 31 and 31′, since the magnetic force acting therebetween is attenuated in inversely proportional to the square of a distance, it is possible to attenuate the magnetic force at once. Therefore, efficiency of the release of the connection is extremely excellent as compared to the above-described lateral slide in which the magnetic force is attenuated in proportion to decrease in opposed areas of the magnet pieces. Therefore, it is possible to easily release or assist the release. By simultaneously performing the lateral slide and the slide to separate, the release or assistance of the release becomes drastically easier.

### (Prevention of Movement in Pulling Direction)

The slide guide structure 41 also has a function to prevent relative movement of each of the coupling pieces 11 and 11′ in the pulling direction of the string body 3 (direction indicated by an arrow P1, refer to FIG. 1) in addition to the above-described function. That is to say, since the pulling direction conforms to the direction across the slide direction (refer to FIG. 1), the relative movement in the pulling direction is prevented in a state in which the slide projected piece 43 is received by the slide groove 45. By this preventing function, there is no fear that the coupling pieces 11 and 11′ are easily separated from each other.

### (Structure for Pressing)

As illustrated in FIGS. 3 to 5, in a state in which the coupling pieces 11 and 11′ attract to join each other, the open end 19 of one coupling piece 11 and an open end 19′ of the other coupling piece 11′ are projected in the slide direction (right-left direction in FIG. 3) from the close end 21′ of the other coupling piece 11′ and the close end 21 of the one coupling piece 11, respectively. That is to say, although the open end 19 is projected to the right than the close end 21′ in FIG. 3, the close end 21 indicated by a broken line in the drawing is hidden under the open end 19′ and is not seen. That is to say, the open end 19′ is projected in the slide direction than the close end 21.

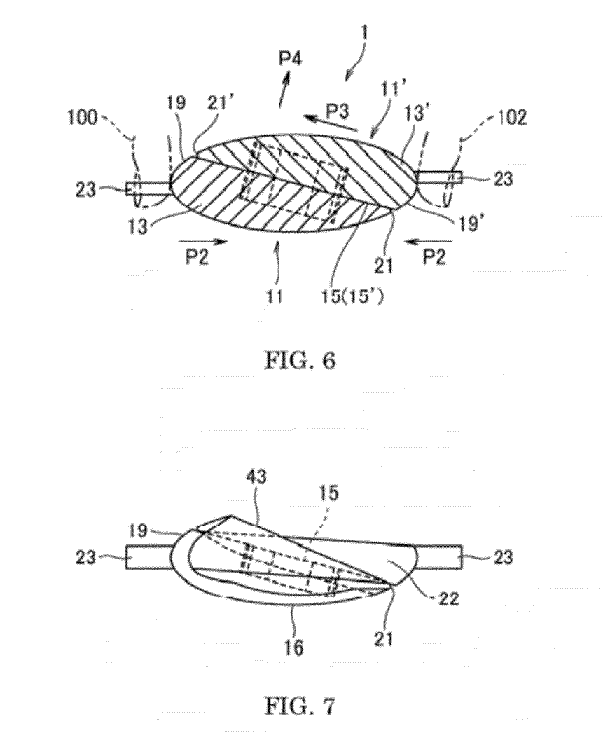

The above-described projection of the open ends 19 and 19′ means that a finger of a user is put only thereon and is not put on the close ends 21 and 21′. A thumb 100 and an index finger 102 indicated by a two-dotted line in FIG. 6 indicate this state. Herein, a direction of relative movement of the coupling piece 11′ with respect to the coupling piece 11 when it is pressed in a direction to shorten a distance between the thumb and the index finger, that is to say, a direction to bring the open ends 19 and 19′ closer to each other (direction indicated by an arrow P2) is in a direction parallel to the joint surfaces 15 and 15′ (direction indicated by an arrow P3) and a direction in which the joint surface 15′ is separated from the joint surface 15 (direction indicated by an arrow P4). The relative movement is performed by operation of the above-described slide guide structure 41.

### First Modified Example of this Embodiment

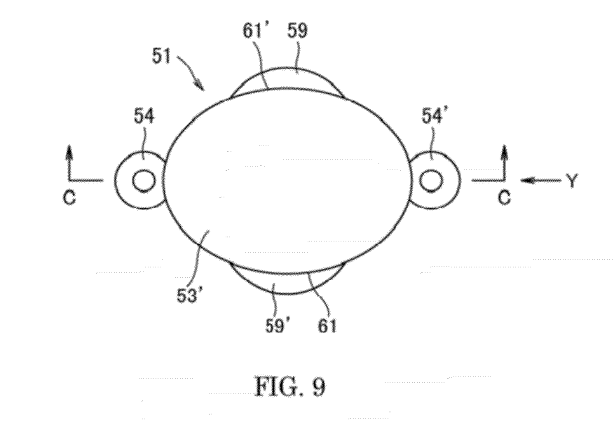

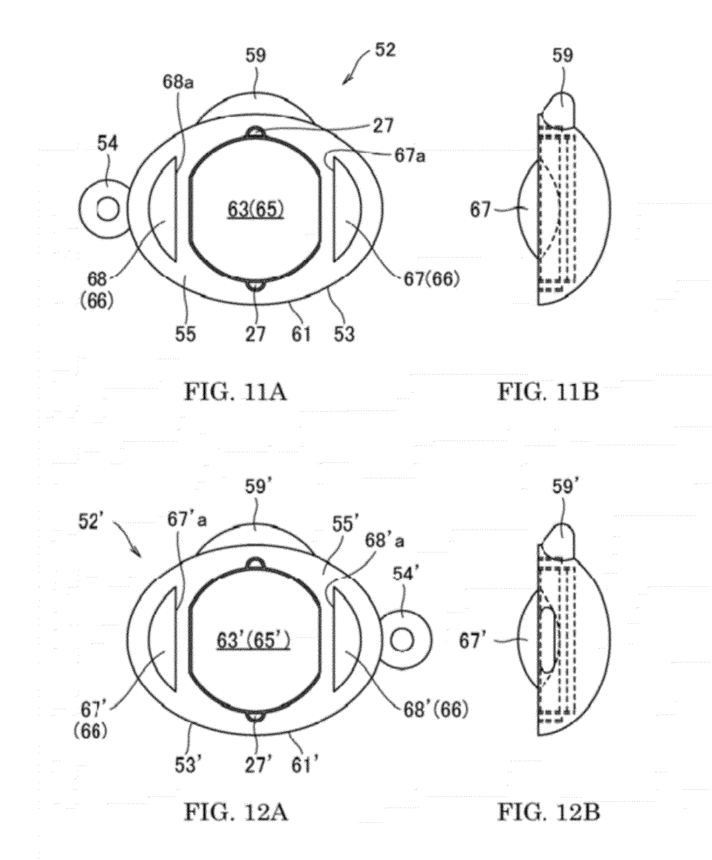

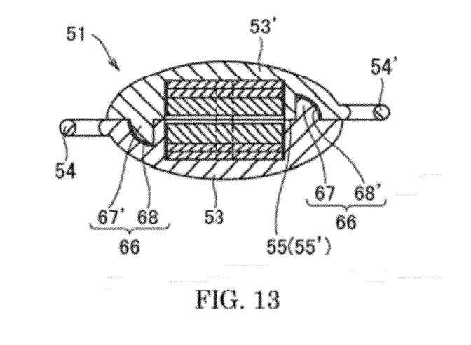

A first modified example of this embodiment is described with reference to FIGS. 9 to 13. In a coupling device 51 according to the first modified example, the connection is released or the release of the connection is assisted by the basically same principle as that of the coupling device 1 described above. Herein, a member different from that of the coupling device 1 is described and the same member name as that used in the coupling device 1 is used in the coupling device 51 for the common member and the description thereof is omitted as far as possible (the same applies to following modified examples).

That is to say, a coupling piece 52 according to the coupling device 51 is provided with a coupling piece main body 53 and an attaching piece 54 and the coupling piece main body 53 is provided with a joint surface 55 (refer to FIG. 11). A magnet piece 65 is embedded in an embedded hole 63 provided on the joint surface 55. A slide projected piece 67, which composes a slide guide structure 66, is formed into a half-dome shape like an egg cut in quarters and a surface abutting a cut edge thereof to be projected from the joint surface 55 becomes a projected wall 67a. A slide groove 68 also is formed by digging into the half-dome shape and a surface corresponding to the projected wall 67a and retreated from the joint surface 55 becomes a retreated wall 68a. A reason why they are formed into the half-dome shapes is that fitting and removal thereof are easy and that it is possible to separate the joint surfaces 55 and 55′ from each other in association with the slide because heights from the joint surface 55 varies in the slide direction (up-down direction in FIG. 11) (refer to FIG. 11(b)). That is to say, although the joint surfaces 55 and 55′ join each other when the slide projected piece 67 is fully fitted to the slide groove 68′, with the slide, an apex of the slide projected piece 67, which has been in contact with a deepest bottom portion of the slide groove 68′, moves from the deepest portion to a shallow portion of the slide groove 68′, the slide projected piece 67 floats by difference in depth. As a result, the joint surfaces 55 and 55′ move in directions away from each other. This is the same as the slide guide structure 41 of the coupling device 1 in that the fitting of the slide projected piece 67 to the slide groove 68′ overcomes force in the pulling direction to maintain a joint relationship.

Reference signs 59 and 59′ in FIGS. 9 to 12 represent extended open ends corresponding to the open ends 19 and 19′ of the coupling device 1. That is to say, the extended open end 59 is obtained by extending the open end of the coupling piece main body 53 to be projected, and an object thereof is to allow the finger of the user to be put only thereon and prevent the fingers from being put on the coupling piece main bodies 53 and 53′. Meanwhile, a reference sign 61 represents a close end.

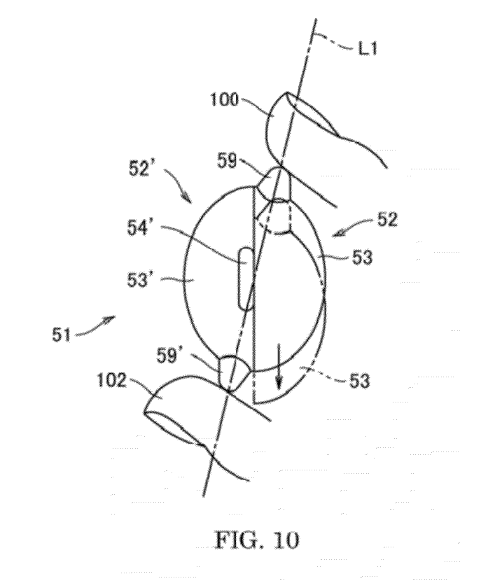

A shape of the extended open end 59 may be composed of a projected piece projected from the coupling piece main body 53, for example. As illustrated in FIG. 10, one projected piece (coupling piece main body 53) and the other projected piece (coupling piece main body 53′) are preferably arranged such that a direction of a virtual straight line L1 passing through both of them intersects the slide direction indicated by an arrow. Since the direction of the virtual straight line L1 intersects the slide direction (since they do not conform to each other), when it is tried to bring the one projected piece (coupling piece main body 53) and the other projected piece (coupling piece main body 53′) closer to each other, the thumb 100 and the index finger 102 put on them are moved in a direction different from the slide direction. When the fingers are moved in the direction different from the slide direction, the fingers do not hit against each other, so that release operation becomes easier. The coupling piece main bodies 53 and 53′ may be used for releasing the connection by pinching them with the fingers to separate from each other.

### Second Modified Example of this Embodiment

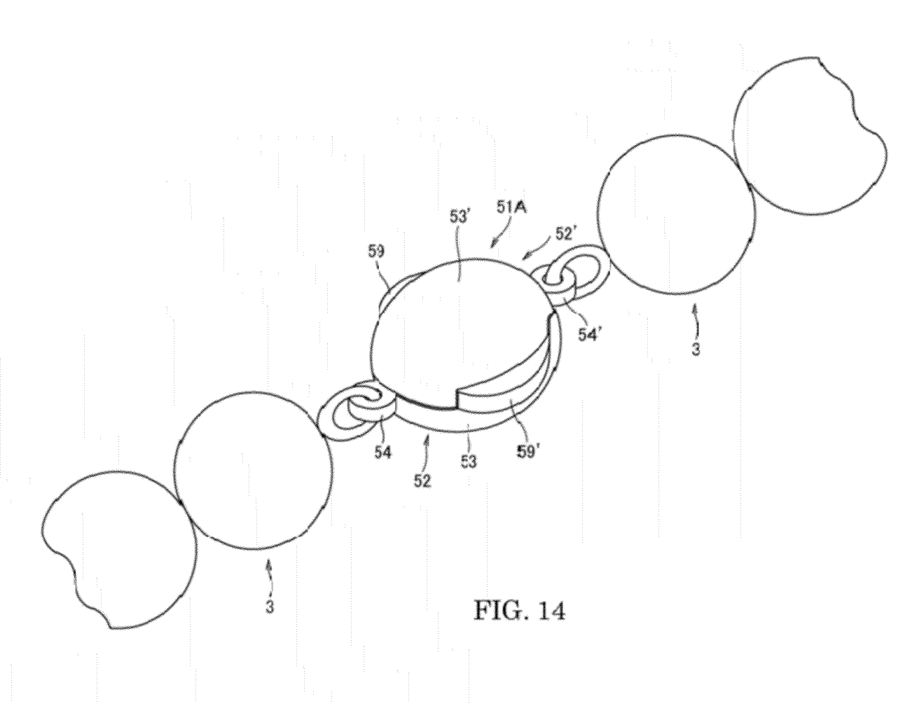

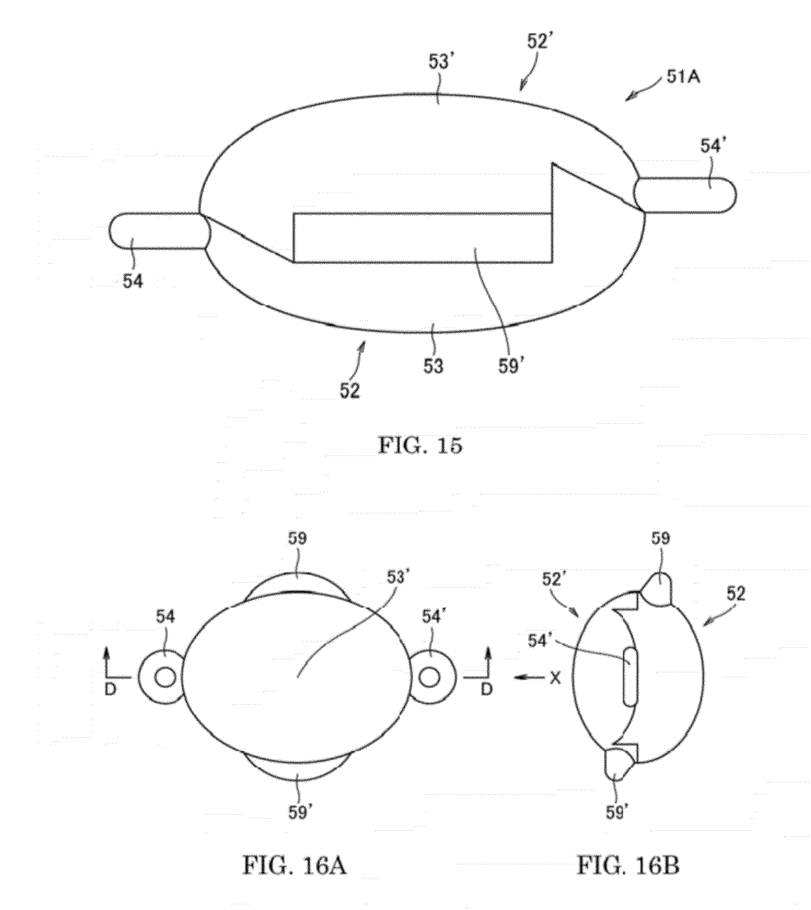

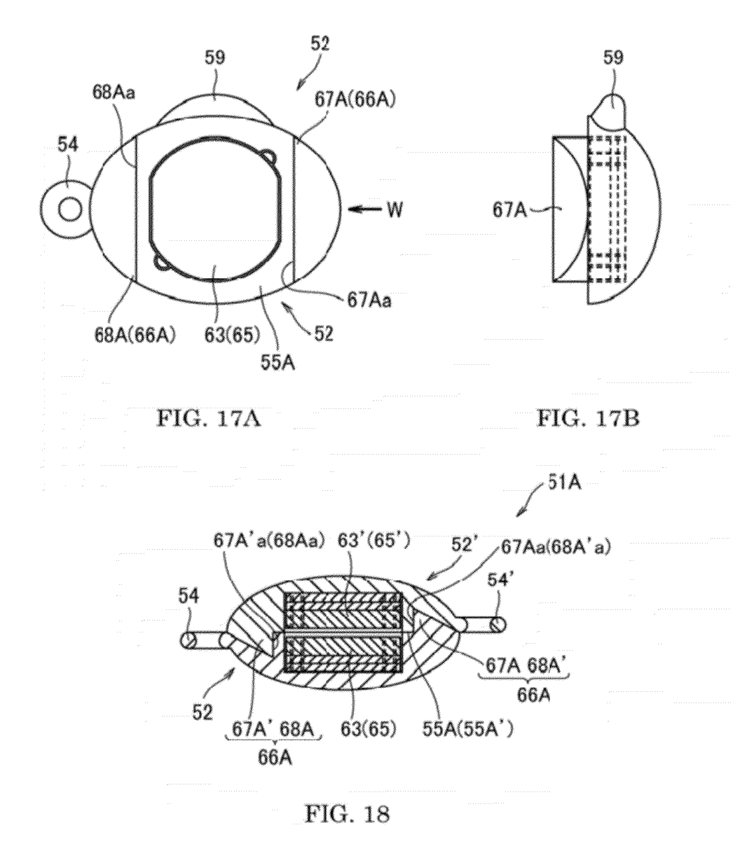

A second modified example of this embodiment is described with reference to FIGS. 14 to 18. A coupling device 51A according to the second modified example, is basically provided with the same structure as the structure of the coupling device 51, and difference therebetween is the slide guide structure of them. Therefore, the same reference sign is assigned to the member common to both and the description thereof is omitted. Hereinafter, the slide guide structure is described.

A slide guide structure 66A of the coupling device 51A is composed of a slide projected piece 67A (slide projected piece 67A′) and a slide groove 68A′ (slide groove 68A). The slide projected piece 67A is formed into a triangular shape in cross section, which inclines upward from one end in the pulling direction inward and vertically drops from an apex (refer to FIG. 18), so that the slide groove 68A′, which receives the same, also is formed into a triangular shape in cross section. A projected wall 67Aa (projected wall 67A′ a) included in the slide projected piece 67A (slide projected piece 67A′) and a retreated wall 68A′a (retreated wall 68Aa) included in the slide groove 68A′ (slide groove 68A) are brought into contact with each other so as to be slidable, and according to this, it becomes possible to slide in a direction perpendicular to a plane of paper of FIG. 18 against the force in the pulling direction (right-left direction in FIG. 18). Meanwhile, although there are two slide projected pieces 67A (slide projected pieces 67A′) and two slide grooves 68A′ (slide grooves 68A) described above, the number thereof may be one or three or more.

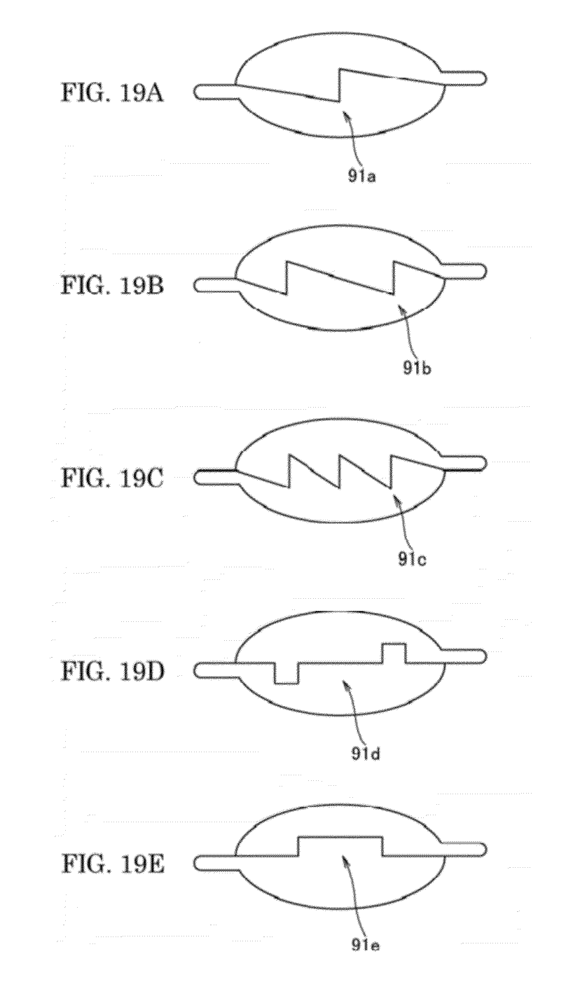

Further, it is also possible to freely change the number and a shape thereof as indicated by reference signs 91a to 91e in FIG. 19. That is to say, the number of steps of a zigzag shape is one in the slide guide structure 91a in FIG. 19(a), the number of steps of the slide guide structure 91b in FIG. 19(b) is two, and the number of steps of the slide guide structure 91c in FIG. 19(c) is three. Two rectangular steps are formed in the slide guide structure 91d in FIG. 19(d) and one rectangular step is formed in the slide guide structure 91e in FIG. 19(e). Although it is not described in detail, it goes without saying that the shape, a size, the number, the polarity and the like of the magnet piece should be set in accordance with the shape and the number of the steps.

### Third Modified Example of this Embodiment

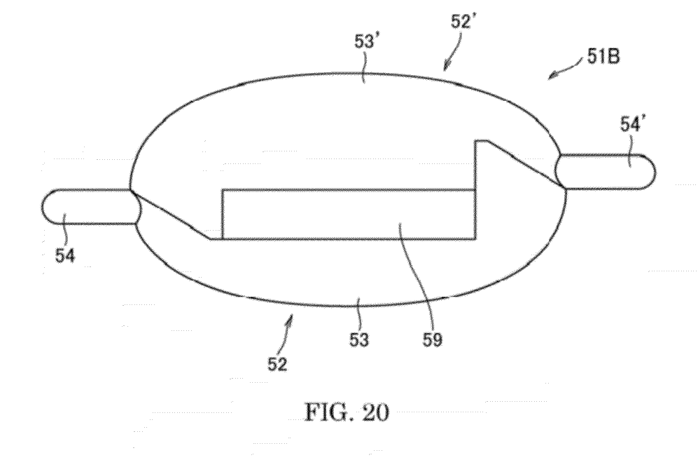

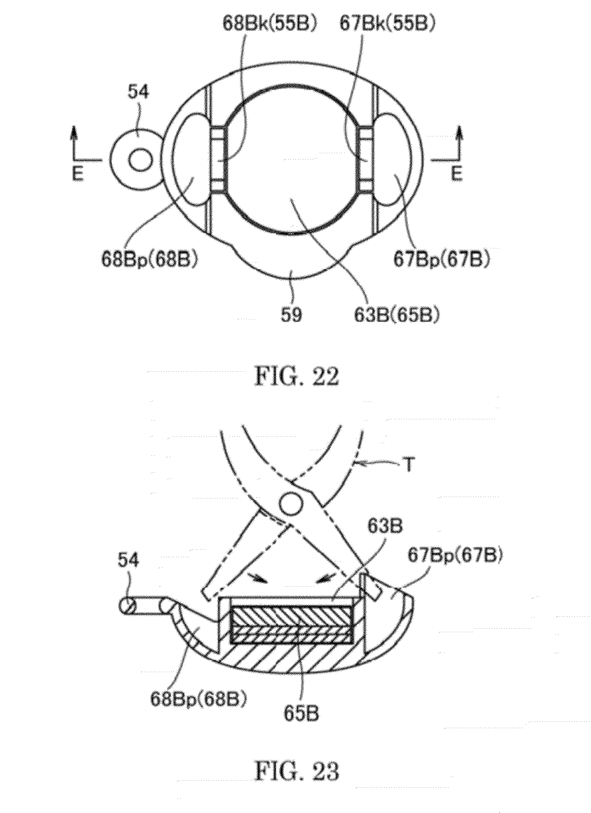

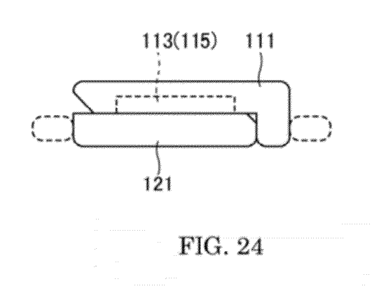

A third modified example of this embodiment is described with reference to FIGS. 20 to 23. A coupling device 51B according to the third modified example is basically provided with the same structure as the structure of the coupling device 51A, and they are different from each other with respect to the slide guide structure and a fixing structure of the magnet of them. Therefore, the same reference sign is assigned to the member common to both and the description thereof is omitted. Hereinafter, the slide guide structure and the fixing structure are described.

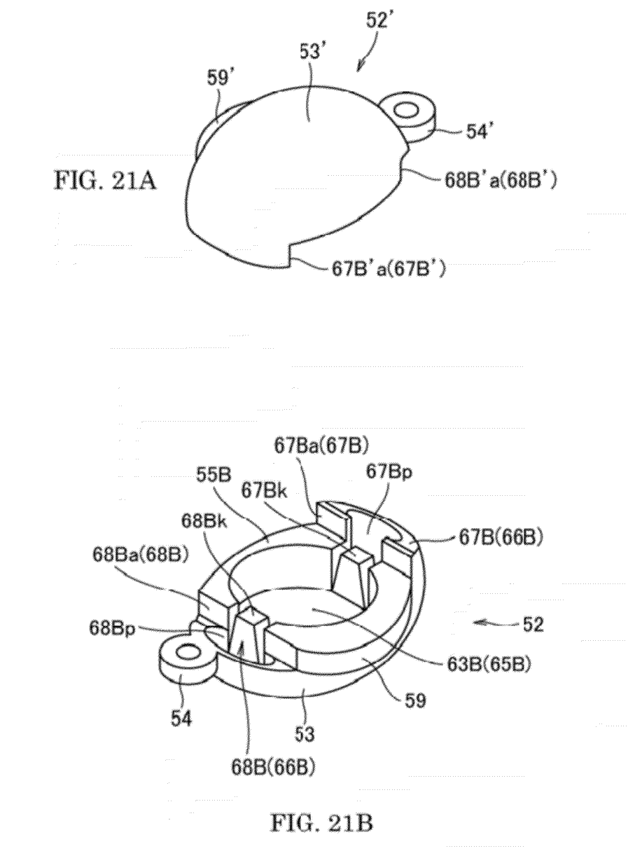

Concave portions 67Bp and 68Bp being in egg-shapes, in a planar view are formed on a slide projected piece 67B and a slide groove 68B, which composes a slide guide structure 66B. As illustrated in FIG. 21, both of the concave portions 67Bp and 68Bp open upward and are laterally communicated with an embedded hole 67Bh. Two fixing claws 67Bk and 68Bk stand between the concave portions 67Bp and 68Bp and the embedded hole 67Bh. The concave portions 67Bp and 68Bp are such that tip ends of a tool T such as pincers are inserted therein, the fixing claws 67Bk and 68Bk are bent inward to be deformed by bringing the inserted tip ends closer to each other, and according to this, a magnet 65B may be fixed in the embedded hole 63B (refer to FIG. 23). This is also for reducing weight. Top surfaces of both of the fixing claws 67Bk and 68Bk compose a part of a joint surface 55B. Meanwhile, a reference sign 67Ba (67B′ a) represents a projected wall included in the slide projected piece 67B (slide projected piece 67B′) and a reference sign 68Ba (68B′ a) represents a retreated wall enclosing the slide groove 68B (slide groove 68′ B).

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope Of the present invention, which is not to be limited except by the following claims.

### EXPLANATION OF REFERENCE NUMERALS

1, 1A, 1B, 51, 51A, 51B . . . magnetic coupling device
3 . . . string body
11, 11A, 52 . . . coupling piece
13, 53 . . . coupling piece main body
15, 15A, 15B, 55, 55B . . . joint surface
16 . . . surface
19 . . . open end
21, 61 . . . close end
22 . . . supporting piece
23, 54 . . . attaching piece
25, 63, 63B . . . embedded hole
27, 67Bk, 68Bk . . . fixing claw
29 . . . receiving concave portion
31, 65, 65B . . . magnet piece
33 . . . yoke
41, 66, 66A, 66B . . . slide guide structure
43, 67, 67A, 67B . . . slide projected piece
43a, 45a, 67a, 67Aa, 67B . . . projected wall
45c, 68a, 68Aa, 68Ba . . . retreated wall
45, 68, 68A . . . slide groove
45a . . . groove bottom of slide groove
59 . . . extended open end
67Bp, 68Bp . . . concave portion
100 . . . thumb
102 . . . index finger
111, 121 . . . magnet
113 . . . tenon
115 . . . mortise
T . . . tool

1. A magnetic coupling device, comprising:
a pair of coupling pieces, wherein
each of the coupling pieces is respectively provided with a pair of coupling piece main bodies including joint surfaces capable of joining each other, wherein at least one magnet piece is embedded in each of the joint surfaces such that the coupling piece main bodies attract to join each other, and wherein an attaching piece for attaching a string body is provided on each of the coupling pieces, and is provided with a slide guide structure formed on a side of the joint surface of each of the coupling piece main bodies for slidingly guiding the other in a predetermined direction with respect thereto and for preventing relative movement of each of the coupling piece main bodies in a string body pulling direction when being pressed to be released.

2. The magnetic coupling device according to claim 1,
wherein the slide guide structure includes a wall projected from the joint surface of each of the coupling piece main bodies and a wall retreated from the joint surface, and is configured such that one of the projected walls and the other of the retreated walls, and the other of the projected walls and one of the retreated walls are brought into sliding contact with each other in the slide direction, and the relative movement in the string body pulling direction is prevented.

3. The magnetic coupling device according to claim 1, wherein
the predetermined direction is inclined with respect to the string body pulling direction.

4. The magnetic coupling device according to claim 1, wherein the magnet piece is provided with at least a pair of the north pole and the south pole arranged in the slide direction on an attracting surface thereof, and positions of the north pole and the south pole in one magnet piece and the other magnet piece are reversed.

5. The magnetic coupling device according to claim 1, wherein at least one or a plurality of laminated yoke pieces are arranged on a side opposite to the attracting surface of the magnet piece.

6. The magnetic coupling device according to claim 1, wherein the slide guide structure is further configured to slidingly guide the coupling pieces in directions away from each other when being pressed to release magnetic joint of the coupling pieces or assist the release.

7. The magnetic coupling device according to any one of claim 1, wherein each of the coupling piece main bodies is such that an open end of one coupling piece main body is projected from a close end of the other coupling piece main body and the open end of the other coupling piece main body is projected from the close end of the one coupling piece main body in a slide direction in a state of attracting to join each other, and is configured to release the magnetic joint of the coupling piece main bodies or to assist the release when the open end of the one coupling piece main body and the open end of the other coupling piece main body are pressed in directions to be brought closer to each other.

8. The magnetic coupling device according to claim 7, wherein each of the open ends is composed of an extended open end formed of a projected piece projected from each of the coupling piece main bodies.

9. The magnetic coupling device according to claim 8, wherein
the one projected piece and the other projected piece are arranged such that a direction of a virtual straight line passing through both of them intersects the slide direction.

10. The magnetic coupling device according to claim 1, wherein the string body is a necklace.
